(19) United States
(12) Patent Application Publication
(10) Pub. No.: US 2013/0343172 A1
(43) Pub. Date: Dec. 26, 2013

(54) OPTICAL PICKUP DEVICE, OPTICAL INFORMATION RECORDING DEVICE, OPTICAL INFORMATION RECORDING METHOD, AND OPTICAL INFORMATION RECORDING MEDIUM

(71) Applicant: HITACHI MEDIA ELECTRONICS CO., LTD., Oshu-shi (JP)

(72) Inventors: Fumio ISSHIKI, Yokohama-shi (JP); Kazuyoshi YAMAZAKI, Yamato-shi (JP)

(21) Appl. No.: 13/923,980

(22) Filed: Jun. 21, 2013

(30) Foreign Application Priority Data
Jun. 22, 2012 (JP) 2012-140517

(51) Int. Cl. G11B 7/1395

(52) U.S. Cl. CPC G11B 7/1395
USPC 369/105; 369/110.02

(57) ABSTRACT

There is disclosed an optical information recording device using a multilayer optical disc as a recording medium, in which the number of components of the device is reduced. The optical disc has, e.g., one recording layer with prepits and a plurality of recording layer without prepits. An optical pickup included in the information recording device includes a switchable lens element to focus laser beams to be applied to the multilayer optical disc onto two adjoining recording layers. A tracking error signal offset obtained for a recording layer with prepits is stored. Recording an information signal into a recording layer from which a tracking error signal cannot be detected is performed, while maintaining the accuracy of positioning on track with respect to the prepits based on the stored offset. When reading out an information signal, tracking control based on the prepits of recorded information signals is exerted.

### INCORPORATION BY REFERENCE

This application relates to and claims priority from Japanese Patent Application No. 2012-140517 filed on Jun. 22, 2012, the entire disclosure of which is incorporated herein by reference.

### BACKGROUND OF THE INVENTION

(1) Field of the Invention

The present invention relates to an optical pickup device, an optical information recording device using the optical pickup device, an optical information recording method, and an optical information recording medium for use in the optical information recording device. The invention particularly relates to an optical pickup device/optical information recording device with a reduced number of components, an optical information recording method, and a multilayer optical information recording medium trackable with improved accuracy at the optical information recording.

(2) Description of the Related Art

An example of background art is found in Japanese Patent Application laid-open No. 2011-118997. In Japanese Patent Application laid-open No. 2011-118997, there is a description that “an object is to provide a pickup device and a recording and readout device capable of recording and reading out information into/from an optical recording medium having a plurality of recording and readout regions in depth direction in an accurate and simple manner”. As structure, there is described an optical recording and readout device with a combination of a first optical system for recording and reading out RF signals by using blue light and a second optical system for acquiring servo signals by using red light.

### SUMMARY OF THE INVENTION

As the storage capacity of an optical disc recording medium increases, both such medium and device are required to be inexpensive. A device configured as in Japanese Patent Application laid-open No. 2011-118997, in which an inexpensive recording medium can be used as a multilayer optical disc, is proposed. However, in the configuration as in Japanese Patent Application laid-open No. 2011-118997, two optical systems for blue light and red light need to be combined and the device has a problem in which its price increases with an increasing number of components of the whole device. In addition, it is necessary to focus a blue light beam and a red light beam to different depths by the same objective lens. As the number of recording layers increases, a difference between the depths of those layers becomes larger. There is a problem in which the device becomes expensive with an increasing number of an optical system for correcting a difference in spherical aberrations. Another problem is how to further improve the accuracy of tracking a multilayer optical disc.

The present invention has been made to solve the above-noted problems and an object of the present invention is to provide an optical pickup device/optical information recording device with a reduced number of components, an optical information recording method, and a multilayer optical information recording medium trackable with improved accuracy by the optical information recording.

The above object, as an example, can be achieved by an aspect of the invention described in the claims.

According to the present invention, there is an advantageous effect of enabling the provision of an optical pickup device/optical information recording device with a reduced number of components, an optical information recording method, and a multilayer optical information recording medium trackable with improved accuracy by the optical information recording.

### BRIEF DESCRIPTION OF THE DRAWINGS

These and other features, objects and advantages of the present invention will become more apparent from the following description when taken in conjunction with the accompanying drawings wherein:

FIG. 1A is a cross-sectional view in thickness direction presenting the structure of a multilayer optical disc medium of related art;

FIG. 1B is a cross-sectional view in thickness direction presenting the structure of a multilayer optical disc medium of related art;

FIG. 1C is a cross-sectional view in thickness direction presenting the structure of a multilayer optical disc medium that is used in an exemplary embodiment of the present invention;

FIG. 1D is a cross-sectional view in thickness direction presenting the structure of a multilayer optical disc medium that is used in an exemplary embodiment of the present invention;

FIG. 2 is a diagram presenting a related art example of a method for applying light beams to a multilayer optical disc with a light beam;

FIG. 3A is a diagram illustrating a problem associated with detecting a tracking error signal;

FIG. 3B is a diagram illustrating the problem associated with detecting a tracking error signal;

FIG. 3C is a diagram illustrating the problem associated with detecting a tracking error signal;

FIG. 3D is a diagram illustrating the problem associated with detecting a tracking error signal;

FIG. 4A is a diagram presenting an example of signal processing generating a tracking error signal;

FIG. 4B is a diagram presenting an example of a tracking error signal offset;

FIG. 4C is a diagram presenting an example of a tracking error signal offset;

FIG. 5A is an overall configuration diagram of an information recording device in an exemplary embodiment of the present invention;

FIG. 5B is a configuration diagram of a differential-push-pull signal generator 30 in the exemplary embodiment of the present invention;

FIG. 5C is a configuration diagram of a differential phase detection signal generator 34a in the exemplary embodiment of the present invention;

FIG. 5D is a configuration diagram of a differential phase detection signal generator 34b in the exemplary embodiment of the present invention;

FIG. 6 is a diagram illustrating a method for applying light beams to a multilayer optical disc in the present invention;

FIG. 7 is a diagram illustrating the method for applying light beams to a multilayer optical disc in the present invention;

FIG. 8 is a flowchart illustrating a learning procedure for a first layer in an exemplary embodiment of the present invention;

FIG. 9 is a flowchart illustrating a learning procedure for second and subsequent layers in an exemplary embodiment of the present invention;

FIG. 10 is a configuration diagram of a waveform storing and reproducing circuit in an exemplary embodiment of the present invention; and

FIG. 11 is a diagram explaining operation of interpolators in an exemplary embodiment of the present invention.

### DETAILED DESCRIPTION OF EMBODIMENTS

In the following, exemplary embodiments of an information recording device according to the present invention will be described. The information recording device in an exemplary embodiment of the present invention is an optical disc device. In its optical system, a light beam generated by a single laser source is applied to a liquid crystal element and the liquid crystal element generates split beams that are convergent or divergent. These split beams are applied to two adjoining layers. Thereby, two tracking error signals are generated. Then, in a control system, by learning and correcting a discrepancy between the two tracking error signals, the discrepancy is corrected within circuitry. This combination of these optical system and control system arrangements enables tracking for non-grooved recording layers and recording and reading out information into/from those layers through the use of a single laser source.

The information recording device in an exemplary embodiment of the present invention is realized by combination of an optical pickup having the optical system and a signal processing circuit having decoding and error correction functions. By building the signal processing circuit in a single integrated circuit chip having the decoding and error correction functions, it is possible to achieve cost reduction, high functionality, and high reliability.

Using the drawings, an embodiment of the present invention is descried as an exemplary embodiment below. To facilitate understanding, parts having the same functions are assigned the same reference numerals in part in the respective drawings and described.

The information recording device of the present exemplary embodiment uses a liquid crystal element (liquid crystal lens element) that provides a lens function as a beam splitting element when a voltage is applied to it, so that servo signals on two recording layers can be acquired and information can be recorded and read out.

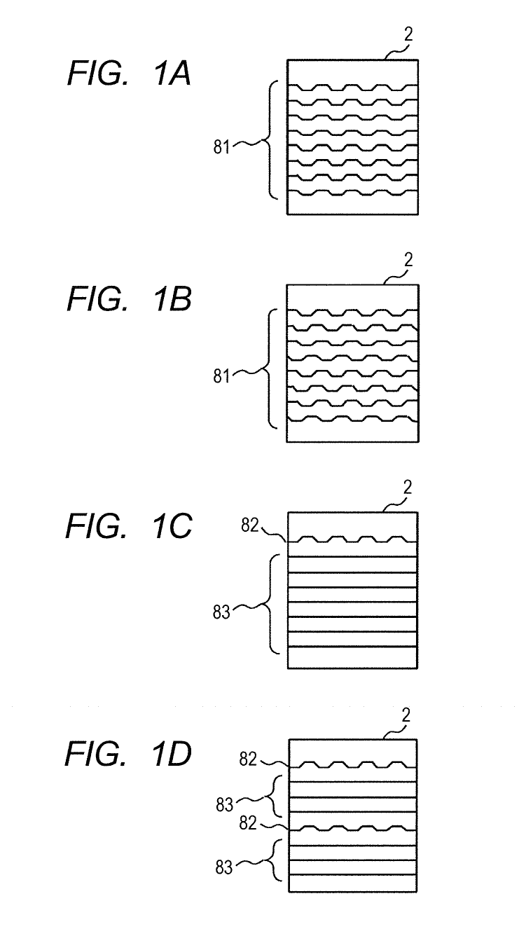

First, using FIGS. 1A through 1D, descriptions are provided about problems associated with a multilayer optical disc medium and with a recording and readout method for such disc.

FIGS. 1A and 1B are cross-sectional views in thickness direction which present a structure of a multilayer optical disc medium of related art.

FIGS. 1C and 1D are cross-sectional views in thickness direction which present a structure of a multilayer optical disc medium that is used in an exemplary embodiment of the present invention.

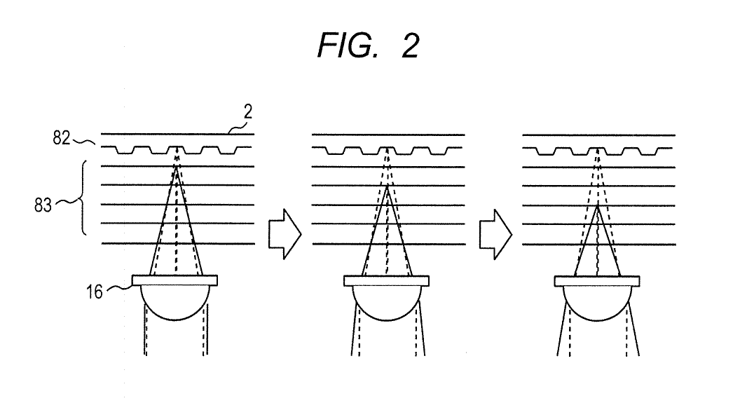

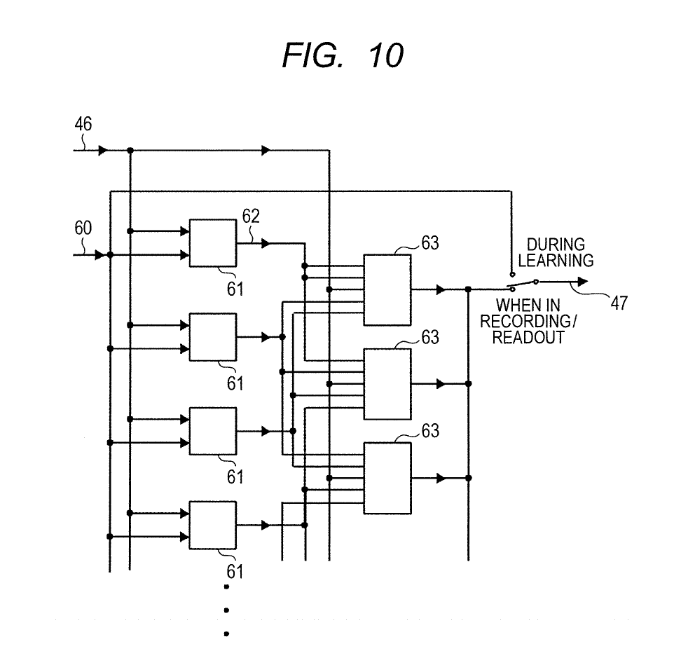

FIG. 2 is a diagram presenting a related art example of a method for applying light beams to a multilayer optical disc presented in FIG. 10.

FIG. 1A presents a cross-sectional structure in thickness direction of a typical multilayer optical disc medium of related art. A disc 2 has a plurality of grooved recording layers (or recording layers with guide prepit) 81 in thickness direction and grooves are formed at regular intervals so that tracking error signals can be generated for each layer. Information can be recorded to and read out from this disc by an optical system having a related art configuration. However, practically in manufacturing, stamper positions for each layer are displaced. Consequently, groove positions are displaced as in FIG. 18 and the disc surface may become uneven and rough. Thus, it is difficult to manufacture good quality discs and the disc price is liable to be expensive.

Therefore, a multilayer disc having non-grooved (flat) recording layers (or recording layers with guide prepit) and provided with only a single guide layer 82 having a groove for tracking control is proposed, as is presented in FIG. 10. In a disc called a grooveless multilayer disc, no information signal is recorded into the guide layer 82 and the guide layer 82 is used only for tracking control and it is also referred to as a servo layer. On the other hand, there is also a disc in which the guide layer 82 having a groove is used as one of the recording layers. The exemplary embodiment of the present invention is applied in each case where either of these discs is used. Thereby, the difficulty of manufacturing discs due to displacement of groove positions is reduced and decreasing the disc price can be expected.

It is also conceivable that the disc 2 has a plurality of guide layers 82 placed at intervals such that a plurality of non-grooved recording layers 83 lie between two guide layers, as is presented in FIG. 1D. This can also be applied to the present exemplary embodiment. In this case also, the difficulty of manufacturing discs due to displacement of groove positions is reduced and the disc price becomes lower in comparison with the disc structure as in FIGS. 1A and 1B. In addition, because a tracking offset is reset and updated for every plurality of recording layers, as will be described later, an improvement in the accuracy of tracking by the information recording device can be expected.

When, for example, the disc 2 presented in FIG. 10 is used and recording and readout are performed, both a blue light beam (a recording and readout light beam depicted with a solid line) that is focused on a non-grooved recording layer (or a recording layer with guide prepit) 83 and a red light beam (a servo light beam depicted with a dotted line) that is focused on a guide layer 82 should be used in related art, as in FIG. 2. Thus, as in Japanese Patent Application laid-open No. 2011-118997, two optical systems are needed, a spherical aberration to be corrected in recording and readout becomes large, and an additional optical system for combining the blue light and red light beams. There is a problem in which the optical pickup has an increased number of components and its price becomes expensive.

What have been described above are the problems associated with a multilayer optical disc medium and with a recording and readout method for such disc.

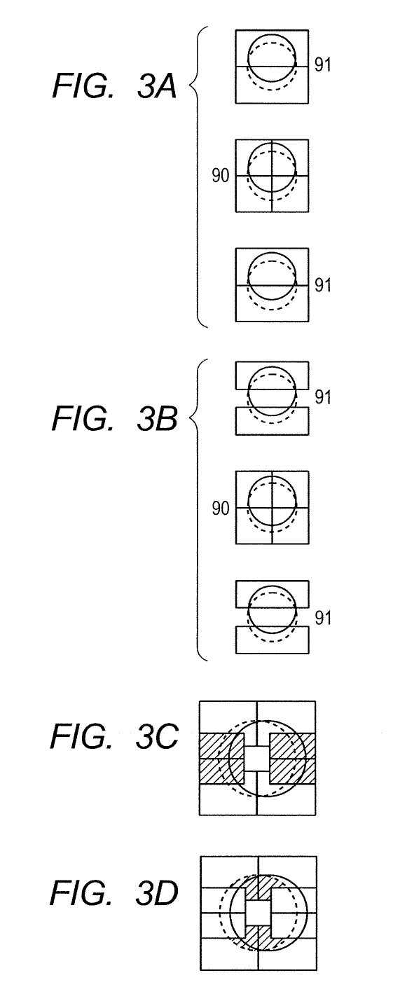

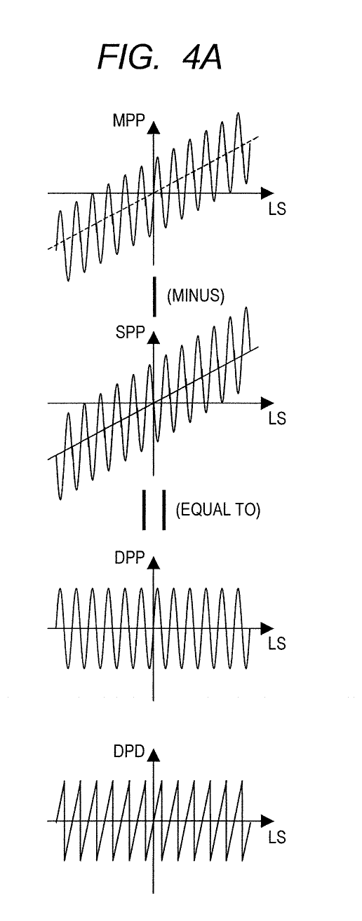

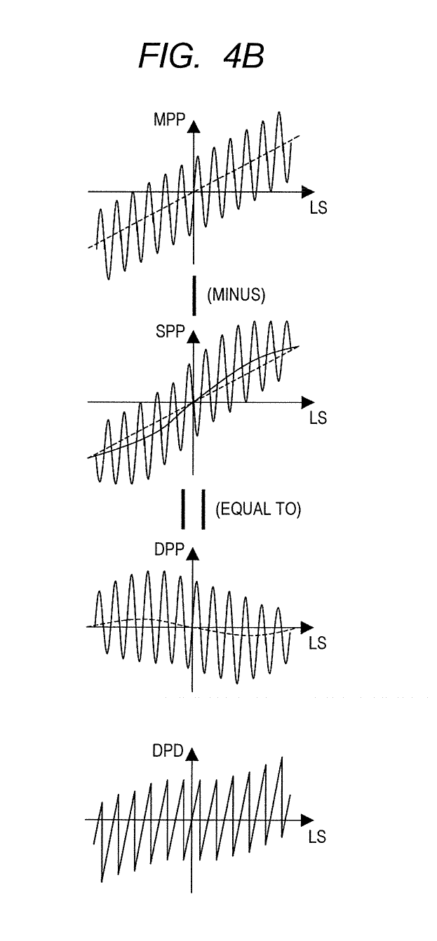

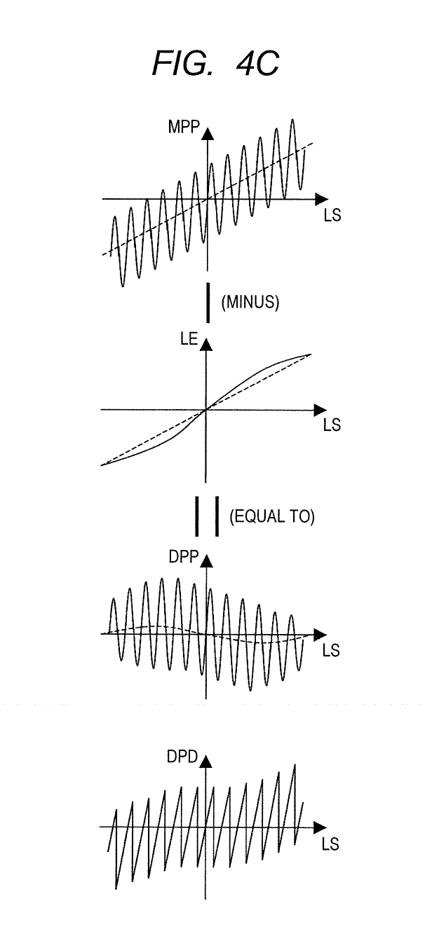

Then, using FIGS. 3A through 3D and FIGS. 4A through 4C, descriptions are provided about a problem associated with an offset of a tracking error signal in an information recording device as an optical disc device.

FIGS. 3A through 3D are diagrams illustrating a problem associated with detecting a tracking error signal.

FIGS. 3A through 3D are diagrams presenting examples of offsets of a tracking error signal.

In order to perform tracking correctly in the event of disc eccentricity, an optical disc device performs signal correction that corrects a tracking error signal which is used for serve control to compensate for the influence of a displacement from the center of a lens (lens shift: LS) occurring due to the disc eccentricity. For example, in the case of a three spots method, as is illustrated in FIG. 3A, two sub-spot acceptance surfaces 91 are placed on both sides of a main spot acceptance surface 90 in a photodetector of an optical pickup. An offset of a push-pull signal detected by the main spot detector surface (main-push-pull signal: MPP) is cancelled out and compensated for by taking a difference between the MPP and a push-pull signal detected by each sub-spot detector surface (sub-push-pull signal: SPP); a so-called differential push pull (DPP) method is used. This corrected push-pull signal is called a differential-push-pull (DPP) signal. In a correctly adjusted differential-push-pull signal, a vertical fluctuation (offset) of the differential-push-pull signal due to a lens shift usually disappears, as is illustrated in FIG. 4A.

However, lately, in a system having a multilayer optical disc with two or three or more recording layers, it is necessary to use a detector surface with a gap in the center portion of a sub-spot detector surface for countermeasures against stray light, as in FIG. 3B. In this case, because the main spot and sub-spot detector surfaces have different shapes, if the spots are moved with a lens shift, the offsets of the MPP signal and the SPP signal are unbalanced, as in FIG. 4B. Especially in the SPP signal, a nonlinear vertical fluctuation (offset) occurs due to a lens shift. Consequently, in a signal obtained by the DPP method in related art, a nonlinear offset occurs in response to a lens shift, which results in a displacement of a beam spot on a recording layer from the center of a track.

The same problem as noted above also occurs in a method for generating a tracking error signal, which is called a one beam method. FIGS. 3C and 3D present an example of a diffraction grating pattern that is used for the one beam method. In FIG. 3C, shaded pattern shows the area that is used to generate an MPP signal. In FIG. 3D, shaded pattern shows the area that is used to generate a lens error (LE) signal corresponding to a lens displacement. The lens error (LE) signal in the one beam method has a role equivalent to the role of the SPP signal in the three beams method. Here, because of different shapes of the areas presented in FIGS. 3C and 3D, a nonlinear offset occurs in the DPP signal in response to a large lens shift, as is presented in FIG. 4C.

Such a nonlinear offset is hereinafter referred to as a nonlinear offset. On the other hand, a linear shift of the offset, as presented in FIG. 4A, is referred to as a linear offset.

Generally, a linear offset can be cancelled out to substantially zero, if it is adjusted properly by the DPP method. In contrast, a nonlinear offset cannot be corrected completely and some nonlinear components remain. If such an offset remains, the course of a beam spot deflects from the center of a track and a recorded mark is displaced from its exact position on the track and deforms out of a true circle.

As another method for generating a tracking error signal, there is a differential phase detection (DPD) method that detects a relative positional displacement between a recorded mark and a beam spot from a readout signal which has been read out from a mark already recorded on the disc. A tracking error signal that is detected by this method is called a differential phase detection (DPD) signal. In the case of the three sports method, a DPD signal is obtained from a phase difference signal among optical signals detected on the four areas of the main spot detector surface 90 presented in FIGS. 3A and 3B. In the case of the one beam method, a DPD signal is obtained from a phase difference optical signals detected on four shaded areas in FIG. 3C or FIG. 3D.

As is the case for the DPP signal, if the spots are moved with a lens shift, an offset occurs in the DPD signal also due to the lens shift, as is presented in FIG. 4B, because of unbalanced light intensity among the optical signals detected on the four areas. Therefore, a similar offset which occurs in the DPP signal also occurs in the DPD signal. Consequently, the problem of a nonlinear offset in response to a lens shift arises in a signal obtained by the DPD method in related art.

Typically, if a disc medium has eccentricity, warpage, or partial deformation, reflected beams become unbalanced and a periodic offset fluctuation in sync with a disc rotation period occurs in both the DPP signal and the DPD signal, with the result that a mismatch occurs between the exact center of a track and the center of tracking control by the DPP signal and the DPD signal.

What has been described above is the problem associated with tracking error signal offsets, which should be solved by the information recording device as an optical disc device of the present exemplary embodiment.

The optical disc device of the present exemplary embodiment is capable of detecting, learning, and correcting periodic offset fluctuation components in the DPP signal and the DPD signal which are the above-mentioned tracking error signals on a per-layer basis. It is featured that the optical pickup and the optical disc device can be configured with a smaller number of components at lower cost by elaborating a tracking method.

### [A Concrete Configuration Example of the Multilayer Optical Disc Device According to the Present Invention]

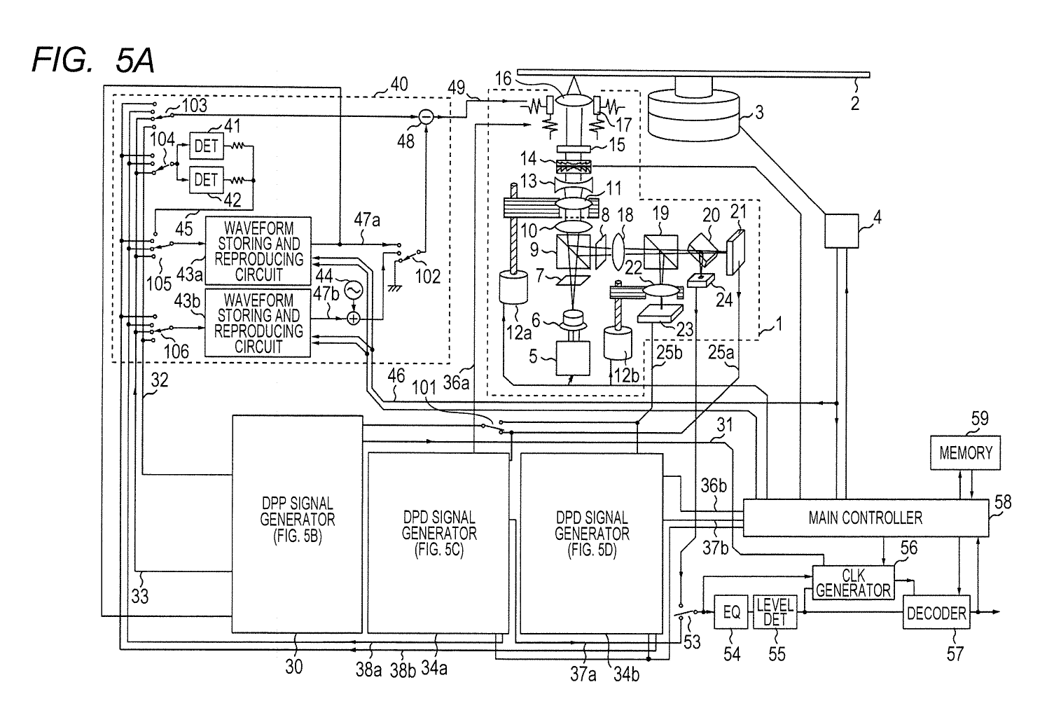

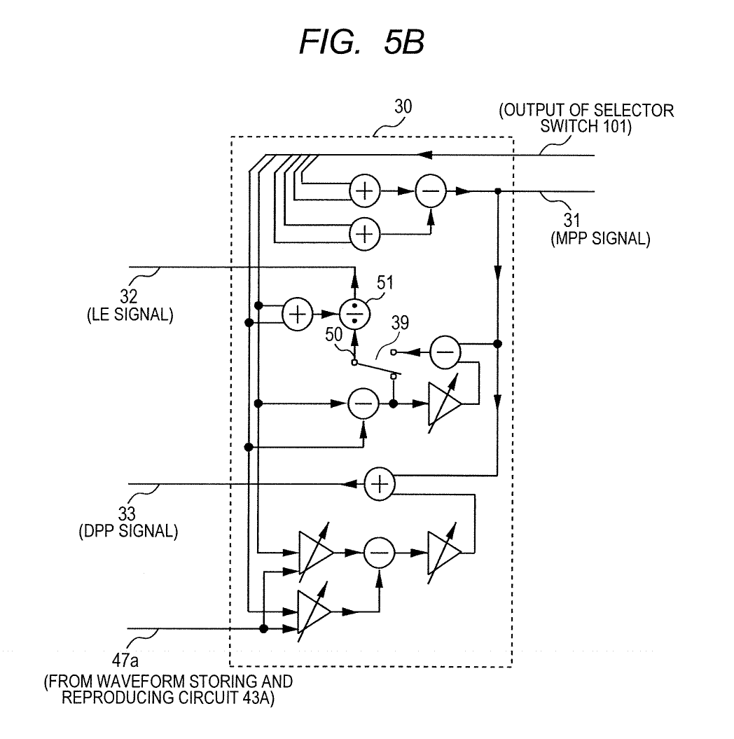

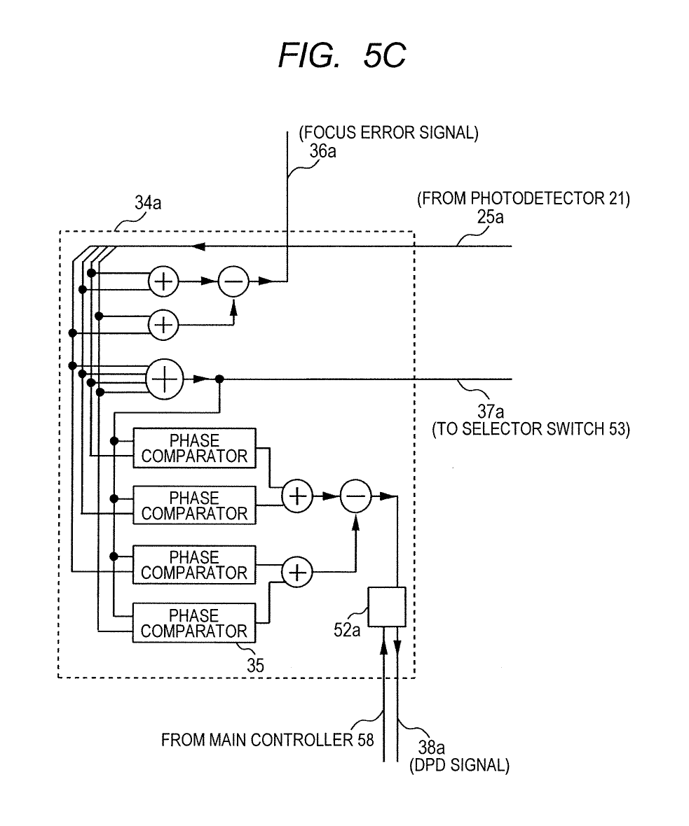

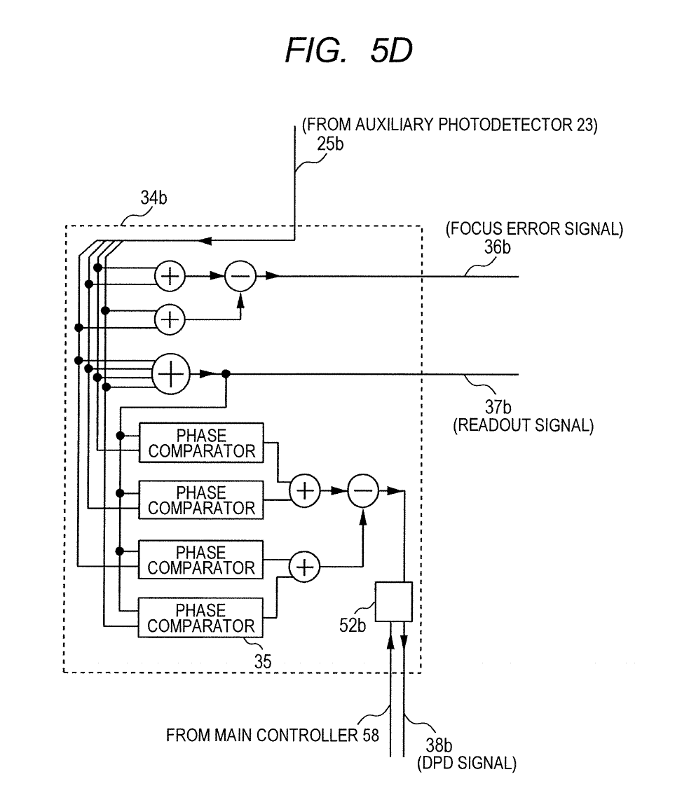

An example of an embodiment of the information recording device according to the present invention is described using FIG. 5A through FIG. 11.

### [An Example of an Overall Configuration of the Multilayer Optical Disc]

FIG. 5A is an overall configuration diagram of the information recording device in an exemplary embodiment of the present invention.

FIG. 5B is a configuration diagram of a differential-push-pull signal generator 30 in FIG. 5A.

FIG. 5C is a configuration diagram of a differential phase detection signal generator 34a in FIG. 5A.

FIG. 5D is a configuration diagram of a differential phase detection signal generator 34b in FIG. 5A.

In FIG. 5A, the information recording device has a mechanism part including an optical pickup section 1, an optical disc 2 which is a removable medium, and a spindle motor 3 as well as a signal processing circuit part.

The optical disc 2 as a recording medium is mounted on the spindle motor 3 whose rotating speed is controlled by a spindle motor controller 4. A light beam from a semiconductor laser 6 driven by a laser driver 5 included in the optical pickup section 1 is applied to this medium.

In the case of the three spots method, a light beam generated by the semiconductor laser 6 passes through a diffraction grating 7 and then is split into three beams. In the case of the one beam method, this diffraction grating 7 is not provided and, instead, a diffraction grating 8 is provided in a return path. In the present exemplary embodiment, the following description assumes a case where the one beam method is used as an example. However the scope of application of the present invention is not limited to this case.

Taking the case of the one beam method as an example, descriptions will be provided below. A light beam generated by the semiconductor laser 6 passes through a polarizing beam splitter 9 and a collimating lens 10 and goes toward a movable lens 11 of beam expander. The movable lens 11 of beam expander is supported on a movable part of a lens driving mechanism and the movable part is configured so that it can be moved in a direction parallel to an optical axis by a stepping motor 12a. The light beam having passed through the movable lens 11 of beam expander passes through a liquid crystal lens element 14.

The liquid crystal lens element 14 serves as a switching lens element that functions as a concave lens providing two levels of intensity when a voltage is applied to it. It converts a part (5 to 30%) of the light beam passing through it to a divergent beam of weak power of the order of 1/300 mm to 1/900 mm. A major part (70 to 95%) of the light beam passing through it is not affected by the lens effect and goes through as is. Thereby, the light beam is split into two components which are respectively focused onto two adjoining layers lower and upper in depth direction. This liquid crystal lens element 14 can be made to function only in an outward path due to its polarized nature. The light beam components having passed through the liquid crystal lens element 14 then pass through a quarter-wave plate 15 and are converged by an objective lens 16, and applied to the optical disc 2, which is a recording medium.

The objective lens 16 is mounted on an actuator 17 so that the focal position can be moved in a focusing direction and a tracking direction by a focus error signal 36a and a corrected tracking error signal 49, respectively. As for each of the above two light beam components, a part of the applied beam is reflected by the disc 2, passes through the objective lens again, passes through a quarter-wave plate 15, now goes through the liquid crystal lens element 14 as it is, passes through a fixed lens of beam expander 13, the movable lens 11 of beam expander, and the collimating lens 10, and then enters a polarizing beam splitter 9. At this time, because the light beam has passed the quarter-wave plate 15 twice, its polarization has been rotated 90 degrees. Thus, the beam is reflected by the polarizing beam splitter 9, passes through a diffraction grating 8 (which is not present in the case of the three beams method), and goes toward a detection lens 18. Most of the beam having passed the detection lens 18 passes through a beam splitter 19 and a semireflecting mirror 20 and is then detected by the detecting surface of a photodetector 21 and converted to a electrical signal.

A remaining part of the beam is reflected by the beam splitter 19 and the semireflecting mirror 20 respectively. The beam reflected by the beam splitter 19 passes through an auxiliary lens 22 and is detected by an auxiliary photodetector 23. This auxiliary photodetector 23 is to detect a beam diverged (or converged) by the liquid crystal lens element 14 and generates a signal which is the basis of a tracking error signal (DPD signal) for a lower layer. The auxiliary lens 22 is supported on a movable part of a driving mechanism and moved in a direction parallel to the optical axis by a stepping motor 12b and functions so as to be able to correct a difference in interlayer intervals of multiple recording layers.

The beam reflected by the semireflecting mirror 20 is detected by a readout signal photodetector 24. This readout signal photodetector 24 exclusively detects an RF signal from an intended recording layer to improve the signal/noise ratio (S/N ratio) of readout signals.

When the liquid crystal lens element 14 is ON, an incident light beam having entered the liquid crystal lens element 14 is split into a light beam (which is called a main beam) that is focused onto a layer into/from which information is recorded and read out and a light beam (which is called a sub-beam) that is focused onto an adjoining layer in depth direction (a lower layer in the present exemplary embodiment). The photodetector 21 is configured so that it can principally accept only a main beam 21 by a way of positioning (or shifting the positions of) the areas of the acceptance surface of the photodetector. Similarly, the auxiliary photodetector 23 is also configured so that it can principally receive only a sub-beam by positioning (or shifting the positions of) the areas of the detector surface of the photodetector. When the liquid crystal lens element 14 is OFF, the light beam is not split into a sub-beam and only its main beam arrives at the photodetector 21. An electric signal generated by the photodetector 21 is amplified by a photocurrent amplifier within the photodetector and a photodetected signal 25a is output. An electric signal generated the auxiliary photodetector 23 is amplified by a photocurrent amplifier within the auxiliary photodetector and a photodetected signal 25b is output.

A differential-push-pull signal generator 30 which is depicted in FIG. 5B is supplied with (takes input of) one of the photodetected signals 25a, 25b selected by a selector switch 101 in FIG. 5A and generates (outputs) an MPP signal 31, a lens error signal 32 (LE signal), and a DPP signal 33. A selector switch 39 performs switching between the three beams method) and the one beam method. In FIG. 5B, the selector switch switched to a position for the one beam method is depicted. In the case of the one beam method, a focus error signal is generated by a knife-edge method. In the case of the three beams method, a focus error signal is generated using a photodetector divided into four sections and by an astigmatic method.

Each of differential phase detection signal generators 34a, 34b, as depicted in FIGS. 5C and 5D, includes phase comparators 35 and, from a photodetected signal 25a, generates a focus error signal 36a, 36b, a readout signal 37a, 37b (RF signal), and a DPD signal 38a, 38b.

Before an output terminal for DPD signal 38a, 38b, there are a sample-and-hold circuit 52a, 52b so that they can hold output value while the driving current of the semiconductor laser 6 is changed during recording operation. The sample-and-hold circuit 52a, 52b allows a DPD signal to pass through it when the intensity of a light beam generated by the semiconductor laser 6 is stable and hold DPD signal obtained during the light intensity stable period during a period when that intensity is unstable. This prevents a modulation in the laser beam intensity from affecting the operation of a tracking servo during signal recording.

According to the configuration above, it is possible to simultaneously generate, as tracking error signals, DPD signals 38a and 38b for the respective two layers from the differential phase detection signal generator 34a and 34b and a DPP signal 33 for one of these layers from the differential-push-pull signal generator 30.

A focus error signal 36a generated is used to drive the actuator 17 that supports the objective lens. According to this signal, the actuator 17 moves the objective lens 16 and focusing control is thereby performed. A readout signal 37a is used to decode an information signal read from the disc. A focus error signal 36b and a readout signal 37b are supplied to a main controller 58 and used for feedback control of the stepping motor 12b.

One of the above readout signal 37a which has been read out from the disc 2 and an output of the above readout signal photodetector 24 is selected by a selector switch 53 in FIG. 5A. Then, the selected signal goes through an equalizer 54, a level detector 55, and a synchronized signal generator 56, and it is converted by a decoder 57 to an original digital information signal recorded. At the same time, the synchronized signal generator 56 directly detects the readout signal, generates a synchronized signal, and supplies it to the decoder 57.

A series of these circuits is controlled overall by the main controller 58. The present configuration is equipped with a non-volatile memory 59 so that initial parameters for the optical pickup, which are required for correction, are retained while the power is off and an initialization operation can be speeded up by using previously learned data.

### [Description of Tracking Error Signal Correction Circuit]

Then, descriptions are provided about a circuit for correcting tracking error signals in a tracking error learning and correction circuit 40. Lens error (LE) signal 32 and DPP signal 33 generated by the differential-push-pull signal generator 30 depicted in FIG. 5B and DPD signals 38a, 38b generated by the differential phase detection signal generators 34a, 34b depicted in FIGS. 5C and 5D are supplied to the tracking error learning and correction circuit 40 which is depicted in FIG. 5A. The tracking error learning and correction circuit 40 includes a maximum level peak detector 41, a minimum level peak detector 42, waveform storing and reproducing circuits 43a, 43b, wobble signal oscillator 44, a subtracter 48 for subtraction with a correction signal, and selector switches 102 to 106 for input signals. One of a DPP signal and two DPD signals are selected by a selector switch 104 and upper and lower envelope signals of the selected signal are generated by the maximum level peak detector 41 and the minimum level peak detector 42, respectively. By averaging these upper and lower envelope signals, an amplitude center level signal 45 of the DPP signal or the DPD signal can be generated. This amplitude center level signal serves as a signal representing an amount of offset of a tracking error signal that should be learned when the tracking servo is OFF.

When the tracking servo is ON, other than a tracking error signal (one of a DPP signal and DPD signals) that is used for the servo at the point of time, the other tracking error signal (remaining DPP and DPD signals) are representing amount of offset of the tracking error signal should be learned.

One of the signal representing the amount of offset of the tracking error signals is selected and stored into a waveform storing and reproducing circuit 43a, 43b in sync with a spindle clock 46. The signal representing the amount of offset is reproduced in sync with the spindle clock 46 again from the waveform storing and reproducing circuit 43a, 43b and a correction signal 47a, 47b is output by this circuit. In this way, a signal representing an amount of offset of a tracking error signal can be stored and restored in sync with disc rotation.

By subtracting a reproduced signal representing the offset from a tracking error signal (DPP signal or DPD signal) for driving the actuator, a beam spot can be readjusted to scan the exact center of a track properly. That is, the reproduced signal representing an amount of offset serves as a signal representing a correction value (correction signal itself). The correction signal is subtracted from a tracking control signal by the subtracter 48 and a corrected tracking error signal 49 in which a displacement from the track center was corrected is eventually output to drive the actuator 17. According to this signal, the actuator 17 moves the objective lens 16 and tracking control is thereby performed.

In the present configuration, two waveform storing and reproducing circuits 43a, 43b are equipted; while one is engaged in generating (reproducing) a correction signal, the other can learn (record) an offset of another signal. The two waveform storing and reproducing circuits 43a, 43b alternately store and reproduce an offset correction value. Thereby, displacements of marks recorded on a recording layer of a multilayer medium can be learned and corrected alternatively and information marks can be recorded, while a proper position on a track can be maintained with high accuracy across a plurality of layers.

Also in the present configuration, a waveform storing and reproducing circuit 43a can select an input signal from among an amplitude center-level signal 45 of a DPP or DPP signal, a DPP signal 33, and DPP signals 38a, 38b by a selector switch 105. A waveform storing and reproducing circuit 43b can select an input signal from among a lens error signal 32, a DPP signal, and DPD signals 38a, 38b by a selector switch 106. For example, the tracking error learning and correction circuit 40 can operate so that an offset signal for a DPP signal 33 is output from one waveform storing and reproducing circuit to execute an offset correction, while an offset signal obtained for a DPD signal 38a, 38b is stored into the reaming one waveform storing and reproducing circuit.

The configuration also includes the wobble signal oscillator 44, a signal from which can be added to an output signal directly output from the waveform storing and reproducing circuit 43b. An input signal to the subtracter 48 can be selected from among three signals, namely, correction signals 47a, 47b and a neutral (non-corrected) signal by a selector switch 102.

In the differential-push-pull signal generator 30 as depicted in FIG. 5B, internally, a lens error signal 32 is first generated which has been modified in terms of a total amount of light intensity detected, based on a source signal of lens error signal 50 and a signal representing a total sum of light intensities detected on the sub-spot acceptance surface areas and using a divider 51. That is, the lens error signal 32 is generated depending on a relative value with respect to the total sum signal, not an absolute value of its source signal 50. This can prevent an erroneous detection of an amount of lens sift due to a variation in the total amount of light intensity of readout signals and is useful in increasing the accuracy of correction in the exemplary embodiment of the present invention.

[Supplementary Description about the Liquid Crystal Lens]

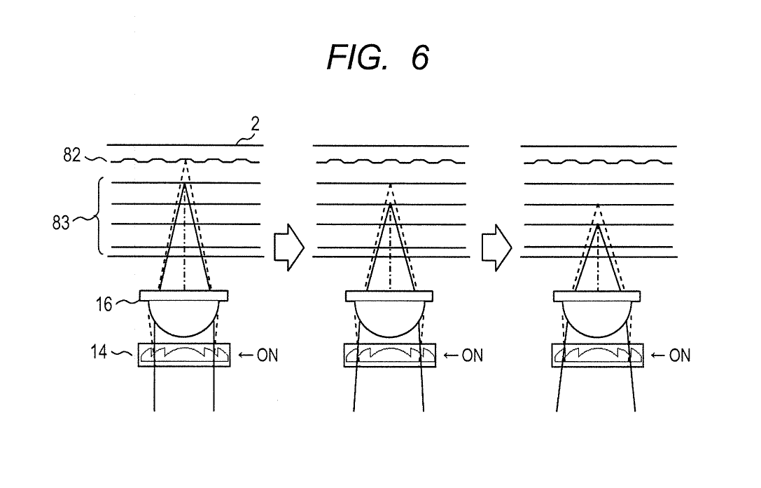

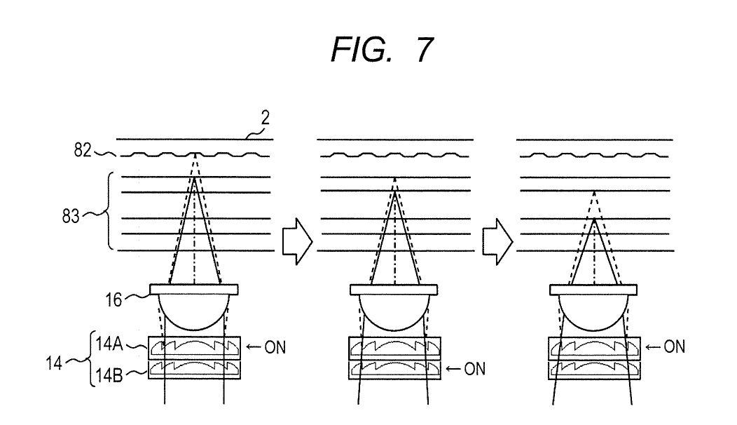

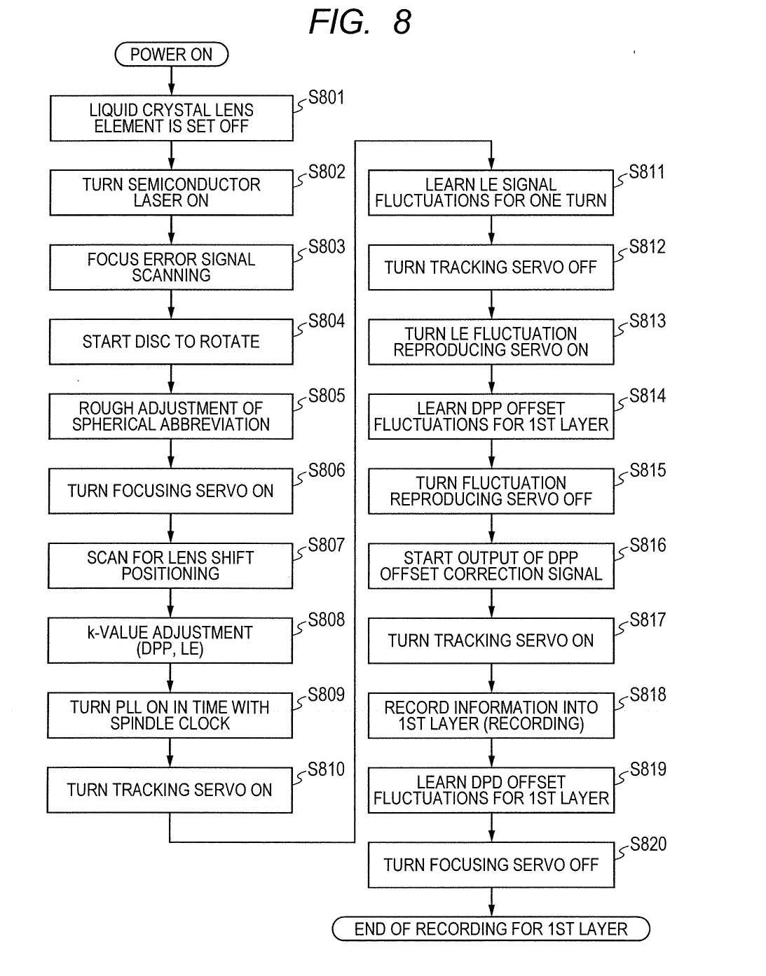

In FIG. 5A referred to previously, the liquid crystal lens element 14 in which two lenses are assembled is depicted. Descriptions are provided about this element, using FIGS. 6 and 7.

FIGS. 6 and 7 are diagrams illustrating a method for applying light beams to a multilayer optical disc in the present invention. FIG. 6 depicts a liquid crystal lens element 14 with a single lens unlike the corresponding element in FIG. 5A and FIG. 7 depicts a liquid crystal lens element 14 with two lenses like the corresponding element in FIG. 5A. For explanatory convenience, descriptions are provided here, assuming a case where a guide layer 82 is a servo layer as an example.

FIG. 6 illustrates an embodiment that uses a disc with both a guide layer 82 and recording layers 83 situated at substantially equal interlayer intervals between adjoining layers. Specifically, when a signal is recorded to the disc 2, the liquid crystal lens element 14 allows most of an incident laser beam to pass through it as is (depicted with a solid line in FIG. 6) and coverts a part of the laser beam to a divergent beam (depicted with a dotted line in FIG. 6). These laser beams are then converged by the objective lens 16 so that the former beam is applied to a recording layer into which a signal should be recorded and the latter beam is applied a recording layer or guide layer lying underneath the recording layer.

After recording a signal into one recording layer, a recording layer to be used is changed in order denoted by arrows in FIG. 6. In this case, because a disc with substantially equal interlayer intervals between adjoining layers is used, the liquid crystal lens element 14 may have one lens power. A spherical aberration depending on the depth of a recording layer into/from which a signal should be recorded or read out can be corrected by positioning the movable lens 11 of beam expander in FIG. 5A in the optical axis direction.

FIG. 7 illustrates an embodiment that uses a disc with different interlayer intervals between adjoining layers, the disc having two interlayer intervals. For a disc provided with a plurality of guide layers, for example, as depicted in FIG. 1D, it is necessary to consider a case in which there are two interlayer intervals.

In that case, the liquid crystal lens element 14 should expediently have two lenses, one with large lens power 14A and the other with small lens power 14B, and one of those liquid crystal lenses which is appropriate for one of the interlayer intervals should be made to function. Of course, one of one lens and two lenses of the liquid crystal lens element may be made to function selectively as appropriate for one of the interlayer intervals.

Through the use of the embodiment as in FIG. 7, it is possible to easily apply the exemplary embodiment of the present invention to a disc with different interlayer intervals between adjoining layers.

[Learning and Recording/Readout Procedure when Recording Information to a Multilayer Optical Disc]

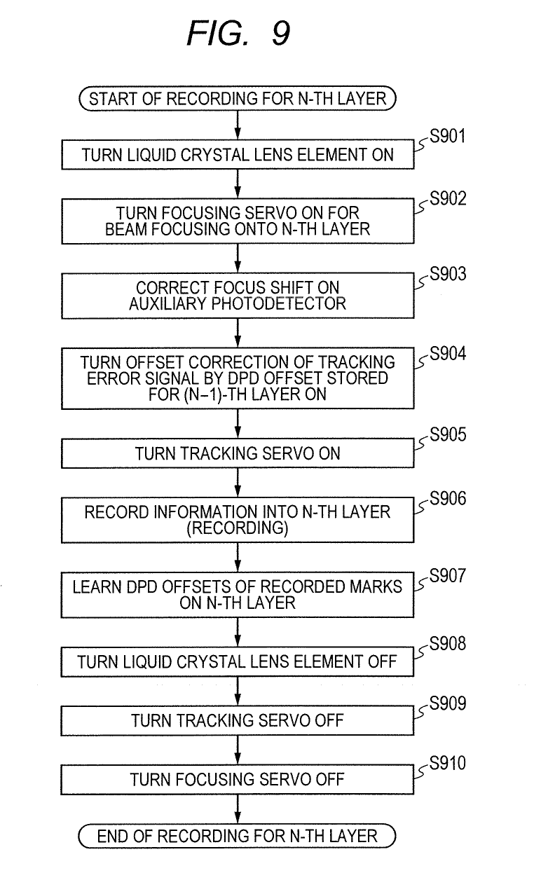

Next, descriptions are provided about a learning and recording/readout procedure, using FIGS. 8 and 9.

FIG. 8 is a flowchart illustrating a learning procedure for a first layer in an exemplary embodiment of the present invention. Here, for example, a guide layer 82 as in FIG. 1C, which is a first layer of the disc, is assumed to be a recording layer into which an information signal can be recorded.

FIG. 9 is a flowchart illustrating a learning procedure for second and subsequent layers in an exemplary embodiment of the present invention.

[A Procedure of Recording into the First Layer]

First, a procedure of learning and recording into the first layer is described, using FIG. 8.

The liquid crystal lens element 14 is set OFF in an initial state (step S801). In this state, optical signals detected by the photodetector 21 are the same as in a general multilayer optical disc. The main controller 58 turns the semiconductor laser 6 ON (S802), performs focus error signal scanning with a vertical lens motion (lens swinging) (S803), and identifies a disc type. Then, the main controller 58 starts the disc to rotate (S804) and performs a rough adjustment by moving the position of the collimating lens (S805). Then, the main controller 58 turns a focusing servo ON (S806). At the point of time, the differential-push-pull signal generator 30 can generate a DPP signal. Therefore, the main controller 58 performs lens shift positioning (S807), adjusts the gains of two variable gain amplifiers in the differential-push-pull signal generator 30, and performs a so-called k-value adjustment in the differential-push-pull method, i.e., learning of kDPP and kLE (S808). Thereby, in a DPP signal, a linear offset of a lens error signal is corrected and only a non-linear offset remains. Hereinafter, this non-linear offset will simply be referred to as DPP signal offset. Then, the spindle motor controller 4 turns its internal phase lock loop circuit (PLL) ON in time with a spindle clock 46 (S809). In this state, the waveform storing and reproducing circuits 43a, 43b becomes enabled to store and reproduce a waveform input thereto in sync with the disc rotation.

In the information recording device of the present configuration, first, three stages of learning are being performed to write marks in the center of a track properly in the recording layer of the first layer (grooved layer; guide layer 82).

First, in the first stage of learning, the above-mentioned DPP signal offset is learned and corrected. The offset is produced by a lens shift that occurs by following disc eccentricity when the focusing servo is active. Therefore, in order to reproduce this state, the main controller 58 first turns the tracking servo ON (S810). Then, the waveform storing and reproducing circuit 43b stores and learns fluctuations of a lens error (EL) signal for one turn of the disc (S811).

Next, in the second stage of learning, the main controller 58 turns the tracking servo OFF, makes the amplitude of a DPP signal visible (S812), and drives the actuator 17 in sync with the disc rotation to reproduce the lens error signal fluctuations learned previously. In particular, the waveform storing and reproducing circuit 43b outputs the stored lens error signal (fluctuated) in sync with the disc rotation and the signal is supplied to the subtracter 48 as a correction signal. As the other input to the subtracter 48, the selector switch 103 selects a real-time lens error signal 32. Thereby, the actuator 17 is driven to reproduce the learned lens error signal fluctuations accurately. As a result, a trace of a lens shift amount which is the same as that when the tracking servo is ON is reproduced in sync with the disc rotation while the tracking servo remains OFF (S813). In the present application, a servo for reproducing this lens shift amount is referred to as an LE fluctuation reproducing servo. In the present configuration, a slight oscillation from the lens shift position can be provided by the wobble signal oscillator 44. That enables a reliable detection of the amplitude of a DPP signal 33 in each lens shift position even for a disc with a small eccentricity. An amplitude center level signal of a DPP signal obtained in this state corresponds to a true center of a track when the tracking servo is ON.

Next, in a third stage of learning, the amplitude center level signal is stored and learned by the other waveform storing and reproducing circuit 43a in sync with the disc rotation (S814). After the learning, the main controller 58 turns the LE fluctuation reproducing servo OFF (S815). Aiming at the thus learned amplitude center, by actuating the tracking servo with a DPP signal, a beam spot can be adjusted to scan the exact center of a track. In particular, the waveform storing and reproducing circuit 43a outputs the stored amplitude center level signal, thereby staring the output of a DPP offset correction signal which is supplied to the subtracter 48 as a correction signal (S816). As for the other input to the subtracter 48, the selector switch 103 selects a real-time DPP signal 33. These operations are controlled overall by the main controller 58 and servo control in DPP tacking mode is turned ON by the main controller (S817).

Tracking servo is thus performed in a condition in which a spot scans the learned center of a track properly. In that condition, information is recorded onto the whole surface of the first recording layer (S818). Once marks have been recorded, a DPD signal can be obtained from the recorded marks. First layer recording is then completed.

In that state, recording marks can be recorded properly in the center of a track on the whole surface of the first recording layer (grooved layer). However, as preparation for recording into a second layer (non-groove layer) that follows, the following fourth stage of learning is being performed.

In the fourth stage of learning, the main controller 58 performs beam focusing on the first recording layer (grooved layer) and learns DPD signal offset fluctuations, while keeping the DPP tracking servo ON (S819). In particular, in sync with eccentricity with the disc rotation, the differential phase detection signal generator 34b can detect a DPD signal having a periodic offset. Thus, the waveform storing and reproducing circuit 43 stores and learns the offset of the detected DPD signal in sync with the disc rotation. The stored DPP signal offset is an offset produced from the marks recorded properly in the center of a track. Therefore, by actuating the tracking servo with a DPD signal so that the DPD signal has the same offset with the offset, a beam spot can be adjusted to scan the exact center of a track properly even with the DPD tracking servo. In particular, the waveform storing and reproducing circuit 43b outputs the stored DPD signal offset which is supplied to the subtracter 48 as a correction signal. As for the other input to the subtracter 48, the selector switch 103 selects a real-time DPD signal 38a. By exerting servo control in that condition, a beam spot can be rectified to scan the exact center of a track properly. The adjustment for the preparation for recording into second and subsequent layers is thus completed. The focusing servo is then turned OFF (S820) and a next procedure for the second and subsequent layers follows.

[A Procedure of Recording into the Second and Subsequent Layers]

Next, the procedure of learning and recording into the second and subsequent layers is described, using FIG. 9.

When recording into the second and subsequent layers (N-th layer) is performed, it is expedient to actuate the tracking servo with a DPD signal, setting the DPD signal offset learned at the end of recording into the (N−1)-th layer as a servo target value. If recording into the second layer is assumed to be performed, N=should be 2. A practical procedure is as follows.

First, the main controller 58 turns the liquid crystal lens element 14 ON (S901) to focus a main beam onto the N-th layer and a sub-beam onto the (N−1)-th layer. In that condition, the main controller 58 turns the focusing servo ON (S902). The liquid crystal lens element 14 produces two levels of divergence power when a voltage is applied to it and emits a main beam and a sub-beam as mentioned previously. While the main beam is focused onto the N-th layer, the sub-beam is often focused onto a portion between the N-th layer and the (N−1)-th layer, not exactly onto the (N−1)-th layer. In that case, there occurs a slight focus shift with respect to the (N−1)-th layer onto which the sub-beam is intended to be focused. However, because this focus shift of the sub-beam is relatively small at the auxiliary photodetector 23, the focus shift is corrected by using a focus error signal 36b as a feedback signal with the stepping motor 12b control. Thus, it is equivalent as the sub-beam is focused onto the (N−1)-th layer (S903).

The differential phase detection signal generator 34b generates a DPD signal from the sub-beam and the tracking error learning and correction circuit 40 reads data of offset fluctuations learned at S819 in FIG. 8 (904) and actuates the tracking servo (S905). The main controller 58 writes marks onto the recording surface by the main beam, thus performing information recording (S906). At this time, the selector switch 103 in the tracking error learning and correction circuit 40 is switched to select the PDP signal in order to actuate the tracking servo with the DPD signal 38b that is generated from the sub-beam focused onto the (N−1)-th layer.

In the present configuration example, it is expedient to select the DPD signal 38a as an input to the subtracter 48 and select a correction value (correction signal 47a or 47b) read from one of the waveform storing and reproducing circuits (43a or 43c) in which the DPD signal offset learned for the (N−1)-th layer is stored, as the correction value for subtraction. In that condition, the main controller 58 writes marks onto the N-th layer using the main beam, thus recording information onto the whole surface of the N-th layer. At the end of recording into the N-th layer, a transition to a readout mode takes place. The tracking error learning and correction circuit 40 stores and learns an offset of a DPD signal 38a produced from the recorded marks on the N-th layer into the other waveform storing and reproducing circuit (43b or 43a) (S907). Upon the completion of learning, the liquid crystal lens element 14 is turned OFF (S908) and the tracking servo and the focusing servo may be turned OFF (S909, S910). Recording/readout and learning for the N-th layer are then completed.

Subsequently, by repeating the same procedure with redefining the set of (N+1)-th and N-th layers instead of the N-th and (N−1)-th layers, even for a multilayer disc having three or more layers, of which the second and subsequent layers are a series of recording layers without a groove or guide prepit (track mark), data for beam spot positioning on track can be copied between recording layers and it is possible to record information additionally, while maintaining the positioning accuracy on track with high accuracy by learning and correction. In addition, as described previously, offset correction values for each layer are stored and reproduced alternately by the two waveform storing and reproducing circuits 43a and 43b. Thereby, it is possible to properly correct an offset occurring in the tracking servo operation for any number of multiple layers by using a minimum memory provided by only the two circuits and, therefore, the circuitry cost can be reduced.

As the above-mentioned copying is repeated several times, the positioning accuracy degrades little by little. In the case of using a disc in which grooved recording layers (where a DPP signal can be produced) are inserted at intervals across a plurality of recording layers, as presented previously in FIG. 1D, it is possible to reset the influence of a beam spot displacement from the track center and improve the tracking accuracy. The main controller 58 can also be configured to enable such a way of operation.

What has been described above is the recording procedure for a case in which information is newly recorded into a plurality of layers of an unrecorded multilayer disc medium.

When recorded information is read out, a DPD signal can be produced with already recorded marks and, therefore, the tracking servo can be actuated using this DPD signal. In readout mode, it is not necessary to turn the liquid crystal lens element 14 ON and, by keeping it OFF, stray light generated by an adjoining layer can be reduced. By using a liquid crystal lens element whose lens function can be set OFF, the influence of stray light from an adjoining layer can thus be reduced and the reliability of the multilayer optical disc in readout mode can be improved. By using a liquid crystal lens element having two levels of power for convergence and divergence, the present embodiment is applicable even for a multilayer disc having varying intervals between adjoining layers, in which the influence of stray light that is multireflected between recording layers can be suppressed.

In a case where information is additionally recorded to a disc in which information has been recorded from the first layer up to an intermediate point in the N-th layer, it is expedient to actuate the tracking servo with a DPD signal, setting DPD signal offsets learned for the (N−1)-th layer and the N-th layer as servo target values, and initiate recording into the N-th layer from the intermediate point. To do this, first, the differential phase detection signal generator 34a generates a DPD signal, based on a signal obtained by the photodetector 21 from a part of a recorded region of the N-th layer, and the tracking servo is actuated. At the same time, a DPD signal offset for the N-th layer is also learned. Then, when an unrecorded region is encountered, a DPD signal offset is learned, based on a signal obtained by the auxiliary photodetector 23 from a region of the (N−1)-th layer. Then, the differential phase detection signal generator 34b generates a DPD signal. Both the offset for the (N−1)-th layer and the offset for the N-th layer are referred to and the tracking servo is employed. In turn, the optical pickup section 1 records information into the unrecorded region.

That is, when information is additionally recorded to a partially recorded disc, the DPD signal used for tracking servo should expediently be switched between the DPD signal 38a and the DPD signal 38b depending on whether the region under processing is a recorded or unrecorded region. For the recorded region, the tracking servo is actuated with the DPD signal that can be produced from the marks already recorded on the N-th layer. For the unrecorded region, the tracking servo is employed with a DPD signal that can be produced from marks recorded on the adjoining (N−1)-th layer. If the recorded region and the unrecorded region coexist in the same track, the DPD signal offset occurring in the recorded region is first learned so that the track center aligns with marks in the recorded region as possible. The tracking servo is carried out so that an offset occurring in the recorded region is learned and reproduced in the unrecorded region, that is, so that the DPD tracking error signal offset occurring in the recorded region is maintained the same even in the unrecorded region. Thereby, marks can be recorded additionally into the unrecorded region without disturbing the alignment on track in the already recorded region.

During recording, the laser beam intensity is modulated at high speed by recording modulation, with the result that DPD signals 38a, 38b generated by the differential phase detection signal generators 34a, 34b become unstable. Thus, during recording, by sample-and-hold circuits 52a, 52b, control is exerted to allow passage of signals only for a certain period when the laser beam intensity is stable and hold the signals for time other than such period. Thereby, the tracking servo with the DPD signal 38a, 38b is made stable even during recording.

In the present configuration, because a tracking signal offset is detected using an average of the upper and lower envelopes of the amplitude of a DPP signal, it is possible to accurately detect a DPP signal offset due to a lens shift caused by disc eccentricity. Also, through the use of the LE fluctuation reproducing servo, a DPP signal offset is learned exactly and corrected in tracking servo mode. Thus, even such a DPP signal offset occurring due to a lens shift caused by disc eccentricity can be corrected and it is possible to make correction of displacements from the track center at higher accuracy. Because marks that are recorded in the first layer can be positioned to be aligned with the track center position at high accuracy, by copying the position, it is possible to improve the positioning accuracy for recording marks that are recorded into the whole multilayer optical disc medium.

While the foregoing context in this exemplary embodiment generally concerns recording information signals to the disc 2, it goes without saying that the present invention can also be applied to an information reproducing device that only performs a readout operation, but does not perform a recording operation.

### Other Detailed Configurations

If the waveform storing and reproducing circuit (43a or 43b) stores a waveform itself, a large-capacity memory is required. If it is desirable to reduce the memory capacity, this circuit may be configured to store an input signal in response to a spindle clock 46 which is output by the spindle motor controller 4 and in sync with the disc rotation and output a signal interpolated by a spline method when data is read out.

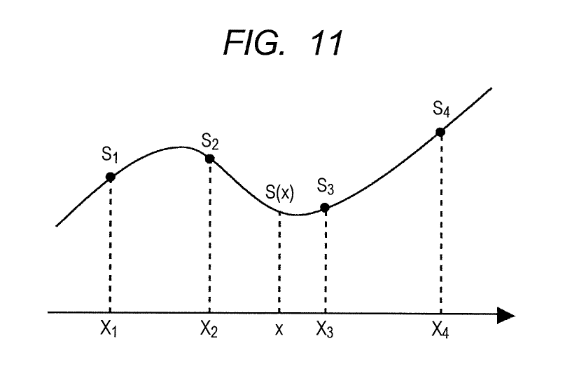

A configuration of the waveform storing and reproducing circuit (43a or 43b) in this case is described in detail, using FIGS. 10 and 11.

FIG. 10 is a configuration diagram of the waveform storing and reproducing circuit (43a or 43b) in an exemplary embodiment of the present invention. The waveform storing and reproducing circuit (43a or 43b) carries out storing the amplitude and the amount of offset of a tracking error signal to be corrected in response to a disc rotation angle (spindle clock 46 herein) and interpolation processing on stored values. Any of a plurality of correction values storing circuits 61, each being responsible for a range of disc rotation angles, works to store an input signal 60 during learning. Stored correction values 62 are output to interpolators 63. Of the interpolators 63, an interpolator 63 responsible for an interpolation range matched with received correction values outputs an interpolated correction signal 47, using stored correction values 62 of four neighbor points and the disc rotation angle. Thereby, an interpolated waveform output in which the points of the stored correction values are interlinked smoothly is generated as an output of the waveform storing and reproducing circuit.

FIG. 11 is a diagram explaining operation of the interpolators 63 in an exemplary embodiment of the present invention. Interpolation processing is performed by a spline interpolation. Its calculation value is approximated by a smooth cubic function as is presented in FIG. 11, where the disc rotation angle is denoted by x and stored correction values 62 are denoted by S, and output. In the learning operation, a, b, c, and d are determined for each section by a calculus equation presented as Equation 1.

$$[ Equation 1 ] \\ ( \begin{matrix}a \\ b \\ c \\ d\end{matrix} ) = {( \begin{matrix}{X}_{1}^{3} & {X}_{1}^{2} & {x}_{1} & 1 \\ {X}_{2}^{3} & {X}_{2}^{2} & {X}_{2} & 1 \\ {X}_{3}^{3} & {X}_{3}^{2} & {X}_{3} & 1 \\ {X}_{4}^{3} & {X}_{4}^{2} & {X}_{4} & 1\end{matrix} )}^{- 1} ( \begin{matrix}{S}_{1} \\ {S}_{2} \\ {S}_{3} \\ {S}_{4}\end{matrix} ) \qquad ( 1 )$$

A value calculated by a calculus equation presented as Equation 2 is output.

[Equation 2]

S(x)=ax³+bx²+cx+d (2)

Consequently, the amount of memory required to store waveforms for the learning is reduced significantly and the controller can be made at low cost.

As described hereinbefore, according to the present configuration, a displacement from the track center in a plurality of adjoining layers is corrected. Even for a multilayer optical disc medium having a plurality of regions and recording layers that in parts lack a groove structure or mark structure allowing a tracking signal to be produced, it is possible to detect and correct beam spot positions on track in adjoining layers and record marks aligned with the track center exactly. A multilayer medium having flat recording layers without a groove structure or prepit can be used and, therefore, the cost of the medium can be reduced. As the optical pickup, a single-color optical system which is less costly can be used without using a related-art configuration, which is of a high degree of difficulty, using both blue and red light optical system. Consequently, it is possible to realize an information recording device as an optical disc device in which both the medium and the device are provided at low cost.

In the foregoing configuration example, the first recording layer of the medium has a groove structure allowing a tracking signal to be produced by the push-pull method. The medium may have the first recording layer that has a prepit (tracking mark) structure allowing a tracking error signal to be produced by the differential phase detection method, instead of the groove structure. In the latter case, because a DPD signal can be obtained directly from prepits (tracking marks), learning can be performed using the DPD signal instead of the DPP signal mentioned in the procedure of recording into the first layer. In the configuration example depicted in FIG. 5A, the present embodiment is made applicable for either of these medium structures by switching the selector switch. In the present configuration example, the circuitry includes the differential-push-pull signal generator 30 and the differential phase detection signal generators 34a, and 34b, and it is possible to produce a tracking error signal by the DPP method and a tracking error signal by the DPD method at the same time for the same recording layer. By selecting and using one of these signals arbitrarily, learning and correction can be performed. Therefore, for either of these medium structures, it is possible to accurately correct a beam spot displacement and record marks in the track center exactly.

The present invention is not limited to the described embodiments and various modifications are included therein. For example, the foregoing embodiments are those described in detail to explain the present invention clearly and the invention is not necessarily limited to those including all components described. A part of the configuration of an embodiment can be replaced by the configuration of another embodiment. To the configuration of an embodiment, the configuration of another embodiment can be added. As for a part of the configuration of each embodiment, another configuration can be added to it or it can be removed and replaced by another configuration.

Some or all of the described components may be configured in hardware or configured to be implemented by executing a program by a processor. Control lines and information lines considered as necessary for explanation are depicted and they do not necessarily represent all control lines and information lines in terms of an article of manufacture. Actually, nearly all components may be considered to be interconnected.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. An optical pickup device that applies a laser beam to a multilayer optical disc having a plurality of recording layers into which an information signal is recorded in its thickness direction and records and reads out the information signal, the optical pickup device comprising:
a laser source generating the laser beam;
a liquid crystal lens element having a first operation mode for splitting a laser beam generated by the laser source into beams and focusing these beams onto both of two adjoining recording layers of the recording layers of the optical disc and a second operation mode for focusing a laser beam generated by the laser source onto any one recording layer of the recording layers of the optical disc;
a first photodetector that is irradiated with a beam reflected by one of the two recording layers which is nearer to the liquid crystal lens element when the liquid crystal lens element is in the first operation mode or is irradiated with a beam reflected by the one recording layer when the liquid crystal lens element is in the second operation mode and detects and outputs an electrical signal from the beam; and
a second photodetector that is irradiated with a beam reflected by one of the two recording layers which is farther from the liquid crystal lens element when the liquid crystal lens element is in the first operation mode and detects and outputs an electrical signal from the beam.

2. An optical information recording device that uses, as a recording medium, a multilayer optical disc having a plurality of recording layers into which an information signal is recorded in its thickness direction, the optical information recording device comprising:
an optical pickup including a laser source generating the laser beam, a liquid crystal lens element having a first operation mode for splitting a laser beam generated by the laser source into beams and focusing these beams onto both of two adjoining recording layers of the recording layers of the optical disc and a second operation mode for focusing a laser beam generated by the laser source onto any one recording layer of the recording layers of the optical disc, a first photodetector that is irradiated with a beam reflected by one of the two recording layers which is nearer to the liquid crystal lens element when the liquid crystal lens element is in the first operation mode or is irradiated with a beam reflected by the one recording layer when the liquid crystal lens element is in the second operation mode and detects and outputs an electrical signal from the beam, and a second photodetector that is irradiated with a beam reflected by one of the two recording layers which is farther from the liquid crystal lens element when the liquid crystal lens element is in the first operation mode and detects and outputs an electrical signal from the beam,
a first differential phase detection signal generator that generates and outputs a differential phase detection (DPD) signal which is a tracking error signal by a differential phase detection method, based on an electrical signal output by the first photodetector in the optical pickup;
a second differential phase detection signal generator that generates and outputs a DPD signal which is a tracking error signal by the differential phase detection method, based on an electrical signal output by the second photodetector in the optical pickup;
a waveform storing and reproducing circuit that is supplied with a DPD signal output by the second differential phase detection signal generator, detects offset components caused by rotation of the optical disc included in the supplied signal, and stores, reproduces, and outputs the offset components; and
a controller that exerts tracking control for controlling a position into which the liquid crystal lens element in the optical pickup focuses the laser beam, based on signals output by the first differential phase detection signal generator, the second differential phase detection signal generator, and the waveform storing and reproducing circuit,
wherein, if an information signal has already been recorded in a recording layer of the optical disc which is farther from the liquid crystal lens element and an information signal is going to be recorded into a recording layer nearer to the liquid crystal lens element, the controller puts the liquid crystal lens element in the optical pickup in the first operation mode, makes the waveform storing and reproducing circuit store the offset components included in a DPD signal generated by the second differential phase detection signal generator, and performs control to record the information signal into the recording layer nearer to the liquid crystal lens element by exerting tracking control based on a signal obtained by subtracting the offset components stored by the waveform storing and reproducing circuit from a DPD signal generated by the second differential phase detection signal generator, and
wherein, if an information signal recorded in a recording layer of the optical disc is going to be read out, the controller puts the liquid crystal lens element in the optical pickup in the second operation mode and performs control to read out the information signal by exerting tracking control based on a DPD signal generated by the first differential phase detection signal generator.

3. The optical information recording device according to claim 2,
wherein one recording layer of the optical disc has a structure for producing a differential-push-pull (DPP) signal which is a tracking error signal by a push-pull method,
wherein the optical information recording device further comprises a differential-push-pull signal generator that generates and outputs the DPP signal based on an electrical signal output by the first photodetector in the optical pickup, and
wherein, if an information signal is going to be recorded into the one recording layer, the controller puts the liquid crystal lens element in the optical pickup in the second operation mode and performs control to record the information signal into the one recording layer by exerting tracking control based on a DPP signal generated by the differential-push-pull signal generator.

4. The optical information recording device according to claim 2,
wherein one recording layer of the optical disc has a structure for producing a DPP signal which is a tracking error signal by a push-pull method,
wherein the optical information recording device further comprises a differential-push-pull signal generator that generates and outputs the DPP signal and a lens error (LE) signal based on an electrical signal output by the first photodetector in the optical pickup, and
wherein, if an information signal is going to be recorded into the one recording layer in which no information signal has been recorded, the controller puts the liquid crystal lens element in the optical pickup in the second operation mode, makes the waveform storing and reproducing circuit store the offset components included in an LE signal generated by the differential-push-pull signal generator, and performs control to record the information signal into the one recording layer by exerting tracking control based on a signal obtained by subtracting the offset components stored by the waveform storing and reproducing circuit from a DPP signal generated by the differential-push-pull signal generator.

5. The optical information recording device according to claim 2,
wherein the first differential phase detection signal generator and the second differential phase detection signal generator include a sample-and-hold circuit for holding a generated DPD signal, and
wherein the controller controls the sample-and-hold circuit to hold a DPD signal generated by the first differential phase detection signal generator and the second differential phase detection signal generator, when the intensity of a laser beam generated by the laser source varies.

6. The optical information recording device according to claim 2, including two waveform storing and reproducing circuits to store offset components for the plurality of recording layers alternately for each layer.

7. The optical pickup according to claim 1,
wherein the liquid crystal lens element includes a plurality of liquid crystal lenses layered in an optical axis direction of a laser beam generated by the laser source and, in the first operation mode, a liquid crystal lens selected from the plurality of liquid crystal lenses depending on an interval between two recording layers onto which laser beams should be focused serves to split the laser beam so as to focus the laser beams onto both of two adjoining layers of the recording layers of the optical disc.

8. The optical information recording device according to claim 2,
wherein the liquid crystal lens element in the optical pickup includes a plurality of liquid crystal lenses layered in an optical axis direction of a laser beam generated by the laser source, and
wherein the controller controls the optical pickup, in the first operation mode, to select a liquid crystal lens from the plurality of liquid crystal lenses depending on an interval between two recording layers onto which laser beams should be focused and split the laser beam so as to focus the laser beams onto both of two adjoining layers of the recording layers of the optical disc.

9. An optical information recording method that applies a laser beam to a multilayer optical disc having a plurality of recording layers into which an information signal is recorded in its thickness direction and records the information signal, wherein one recording layer has a structure for producing a DPP signal which is a tracking error signal by a push-pull method and a lens error (LE) signal, the optical information recording method comprising:
generating the DPP signal and the LE signal from the one recording layer and detecting offset components included in the LE signal;
subtracting the detected offset components from the generated DPP signal and exerting tracking control on the one recording layer;
recording the information signal into the one recording layer,
when having recorded information signals onto the whole surface of the one recording layer, generating a DPD signal which is a tracking error signal by a differential phase detection method from the information signal recorded on the one recording layer and detecting offset components included in the DPD signal;
splitting a laser beam to be applied to the optical disc by a liquid crystal lens element and focusing split beams onto both the one recording layer and a recording layer adjoining the one recording layer;
subtracting the offset components from a DPD signal generated based on a laser beam focused onto the one recording layer and exerting tracking control on the adjoining recording layer; and
recording the information signal into the adjoining layer.

10. An optical information recording medium having a plurality of recording layers into which an information signal is recorded in its thickness direction,
wherein the recording layers include a plurality of first recording layers having a structure for generating a DPP signal which is a tracking error signal by a push-pull method and a plurality of second recording layers not having a structure for generating a tracking error signal when no information signal has been recorded therein, and
wherein the first recording layers are placed to sandwich the second recording layers in the thickness direction.
